(19) United States
(12) Patent Application Publication
(10) Pub. No.: US 2025/0345791 A1
(43) Pub. Date: Nov. 13, 2025

(54) DIAGNOSTIC CARTRIDGE

(71) Applicant: Pebble-i Inc., Gunpo-si (KR)

(72) Inventor: Soo Hong KIM, Gwangju-si (KR)

(73) Assignee: Pebble-i Inc., Gunpo-si (KR)

(21) Appl. No.: 19/204,632

(22) Filed: May 12, 2025

(30) Foreign Application Priority Data
May 10, 2024 (KR) 10-2024-0062153
Apr. 10, 2025 (KR) 10-2025-0046758

(51) Int. Cl. B01L 3/00

(52) U.S. Cl. CPC B01L 3/502715; B01L 2200/027; B01L 2200/16; B01L 2300/041; B01L 2300/0681

(57) ABSTRACT

An in vitro diagnostic technique is disclosed. A diagnostic cartridge proposed herein includes a sample inlet, a filter located at a downstream portion of the sample inlet and separating serum from an injected sample, a plurality of wells located at a downstream portion of the filter, and a microchannel branched from the sample inlet to each of the plurality of wells and interfaced to be eccentric from a center line of each well.

### CROSS-REFERENCE TO RELATED APPLICATION(S)

This application claims priority from Korean Patent Application No. 10-2024-0062153, filed on May 10, 2024, and Korean Patent Application No. 10-2025-0046758, filed on Apr. 10, 2025, in the Korean Intellectual Property Office, the disclosure of which is incorporated herein by reference in its entirety.

### BACKGROUND

### 1. Field

The present disclosure relates to a medical technology, particularly in the field of in vitro diagnostics.

### 2. Description of Related Art

In the medical diagnostic field, there is a technology known as chemical colorimetric assay for detecting specific components contained in biological samples such as blood, serum, urine, and cell fluid. Among point of care testing (POCT) devices, diagnostic cartridges utilizing microfluidic technology are widely used in clinical settings because they can perform multiple analyses with a small number of specimens, shorten testing time, and increase convenience.

Such diagnostic cartridges are generally made of an inlet for injecting specimens, a path for distributing the specimens to multiple reaction areas, and a reaction area where a reagent for detecting a specific biomarker is applied. However, such diagnostic cartridges have a problem in that the mixing of reagents and specimens within the reaction area is incomplete, which reduces detection sensitivity and accuracy.

Above all, although effective reagent-specimen mixing within the reaction area, i.e., well, is an important factor that directly affects the accuracy of diagnosis, existing cartridges mainly rely on simple diffusion or use a method that promotes mixing through a complex external device. This has caused problems that have led to delayed testing time, equipment complexity, and increased costs.

In particular, innovative designs are needed that can maximize the mixing efficiency of reagents and specimens by utilizing fluid dynamics principles to generate natural vortices within the reaction area without the aid of external devices.

### SUMMARY

This summary is provided to introduce a selection of concepts in a simplified form that are further described below in the Detailed Description. This summary is not intended to identify key features or essential features of the claimed subject matter, nor is it intended to be used as an aid in determining the scope of the claimed subject matter.

The present disclosure is directed to achieving even mixing of a specimen introduced through a microchannel in a cartridge and reagents in different wells each containing one of a plurality of reagents.

According to one aspect of the disclosure proposed to achieve the above objective, in a diagnostic cartridge, a sample introduced from a microchannel into a well causes a rotary flow inside the well. According to an additional aspect, each well may have a shape that is advantageous for the rotary flow, for example, a circular or elliptical shape.

According to an additional aspect, in the diagnostic cartridge, a reagent may be applied on a cover and each position on a base corresponding to one of a plurality of wells, and a different reagent may be applied for each well.

According to an additional aspect, in the diagnostic cartridge, a turbulence may be generated inside each well, and a reagent may be evenly mixed with a specimen sample.

According to an additional aspect, the diagnostic cartridge may include a first housing in which a sample inlet is formed and a second housing separately formed from a microchannel and the first housing and having a plurality of wells formed therein.

According to an additional aspect, the diagnostic cartridge may have a plurality of adhesive layers interposed between a lower surface and an upper surface of the second housing that opposes the lower surface, and the plurality of adhesive layers may each be fastened to a different type of filter.

According to an additional aspect, the diagnostic cartridge may have a spacer and a base that belong to the second housing and a plurality of adhesive layers interposed between the spacer and a cover.

Other features and aspects will be apparent from the following detailed description, the drawings, and the claims.

### BRIEF DESCRIPTION OF THE DRAWINGS

FIG. 1 is an external perspective view of a diagnostic cartridge according to an embodiment.

FIG. 2 is an exploded perspective view of the diagnostic cartridge according to an embodiment.

FIG. 3 is a cross-sectional view along line A-A′ of the diagnostic cartridge according to one embodiment illustrated in FIG. 1.

FIG. 4 is a plan view of a spacer showing a pattern of a microchannel according to an embodiment.

FIG. 5 is an enlarged plan view of a well that belongs to the pattern of the microchannel according to an embodiment.

FIG. 6 is a cross-sectional view along line B-B′ of the well that is illustrated in FIG. 5.

FIG. 7 is a flowchart of a process of manufacturing the diagnostic cartridge according to an embodiment.

Throughout the drawings and the detailed description, unless otherwise described, the same drawing reference numerals will be understood to refer to the same elements, features, and structures. The relative size and depiction of these elements may be exaggerated for clarity, illustration, and convenience.

### DETAILED DESCRIPTION

The above-described and additional aspects are embodied through embodiments described herein with reference to the accompanying drawings. It should be understood that components of each embodiment may be combined in various ways within one embodiment or with components of another embodiment unless mentioned otherwise or contradictory to each other. Terms used in the present specification and the claims should be interpreted as having meanings and concepts consistent with the description or proposed technical spirit based on the principle that the inventor may appropriately define the concept of a term in order to describe his or her invention in the best possible way.

Hereinafter, the present disclosure will be described in detail through preferred embodiments described with reference to the accompanying drawings for those skilled in the art to easily understand and reproduce the present disclosure. Although specific embodiments are shown in the drawings and detailed descriptions thereof are given, it is not intended to limit various embodiments of the present disclosure to specific forms. In describing the present disclosure, when a detailed description of a related known function or configuration is determined as having the possibility of unnecessarily obscuring the gist of the embodiments of the present disclosure, the detailed description thereof will be omitted.

When a certain component is mentioned as being “connected” or “linked” to another component, it should be understood that, although the component may be directly connected or linked to the other component, another component may be present therebetween. On the other hand, when a certain component is mentioned as being “directly connected” or “directly linked” to another component, it should be understood that another component is not present therebetween.

Hereinafter, preferred embodiments of the present disclosure will be described in detail with reference to the accompanying drawings.

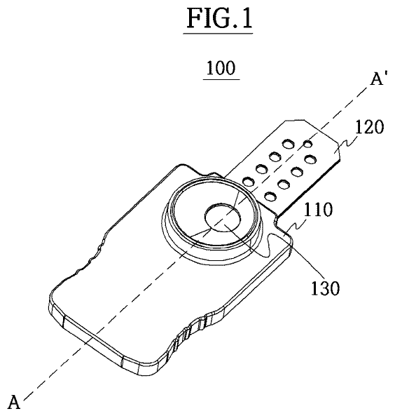

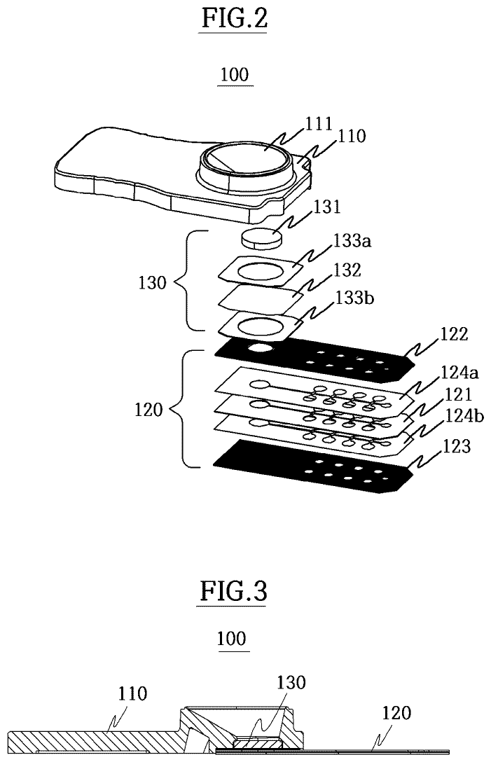

According to one aspect, in a diagnostic cartridge 100, a sample introduced from a microchannel 121b into a well 121a causes a rotary flow inside the well 121a. FIG. 1 illustrates an external perspective view of the diagnostic cartridge 100 according to one embodiment to which such an aspect is applied. FIG. 2 is an exploded perspective view of the diagnostic cartridge 100 according to one embodiment that is illustrated in FIG. 1. FIG. 3 is a cross-sectional view along line A-A′ of the diagnostic cartridge 100 according to one embodiment that is illustrated in FIG. 1. The present disclosure will be described using the embodiment with reference to FIGS. 1 to 3.

The diagnostic cartridge 100 according to one embodiment includes a sample inlet 111, a filter layer 130, a plurality of wells 121a, and a microchannel 121b.

The sample inlet 111 is a space through which a sample, for example, a specimen such as blood, is injected or input. The sample inlet 111 may be formed in a circular shape as illustrated in FIG. 2, but the sample inlet 111 is not limited thereto and may also be formed in a polygonal shape. A user may drop a fluid sample, which is an analysis target, into the sample inlet 111 using a tool such as a pipette. However, since the size reduction of the diagnostic cartridge 100 also limits the size of the sample inlet 111, when the size of the sample inlet 111 decreases, it may not be easy to accurately drop the fluid sample into the sample inlet 111.

As illustrated in FIGS. 1 to 3, in the diagnostic cartridge 100 according to one embodiment, the sample inlet 111 may have the shape of a funnel that is wide at the top and narrow at the bottom. In one embodiment, the sample inlet 111 may be designed to have a diameter of about 8 to 15 mm at the top and a diameter of about 1 to 8 mm at the bottom, but this is only an example related to the size, and the sample inlet 111 may be formed in various other sizes in consideration of the overall size of the diagnostic cartridge 100, the number of supply holes, the type of fluid sample to be analyzed, and the like. Such a structure may facilitate injection of a viscous sample such as blood.

The filter layer 130 is located at a downstream portion of the sample inlet and separates serum from the injected sample. In diagnostics, centrifugation is most efficient and highly reliable among techniques for separating serum, but since centrifugation requires rotation at 5,000 RPM or more, centrifugation has a characteristic that it cannot be applied to a desktop or a mobile device in which the size of equipment is important. Since physical properties, such as viscosity, of blood cells significantly vary for each type, it is not easy to separate serum by utilizing a filter, but a filter for separating serum has been commercialized recently. The filter layer 130 according to one embodiment may include a plurality of pores and two or more layers of porous membranes that filter materials whose sizes are larger than the size of the pores from inside the fluid sample.

The plurality of wells 121a is located at a downstream portion of the filter. The well 121a is a space in which a reagent causing a color reaction for diagnosis is fixed and the sample introduced thereinto reacts with the reagent and develops color. According to an additional aspect, each well 121a may have an elliptical or spherical shape. Further, a partial section of an outer shape of each well 121a may have an elliptical or spherical shape or a substantially elliptical or spherical shape. For example, the well 121a may be formed by a method in which a cover 122 and a base 123 are adhered to above and below a spacer 121 patterned in the form of the well 121a, and a space formed in the spacer 121 forms a void due to the cover 122 and the base 123. In still another example, the well 121a may be formed by adhering the base 123 and the cover 122 that are molded.

The microchannel 121b is branched from the sample inlet to each of the plurality of wells 121a and is interfaced to be eccentric from a center line of each well 121a. In this way, the microchannel 121b is designed so that the introduced sample reaches the inside of the well 121a via the microchannel 121b and forms a turbulence. The microchannel 121b may have a width of 1 μm to 500 μm.

The present disclosure is not limited thereto, and the microchannel 121b may also have one of various other structures that facilitate sample injection, for example, a capillary tube shape. According to one embodiment, the microchannel 121b may be fabricated so that diagnosis is possible even when the amount of specimen such as blood is small.

FIG. 5 illustrates an enlarged plan view of the well 121a that belongs to the microchannel pattern according to an embodiment.

As illustrated in FIG. 5, the plurality of wells 121a may each have a shape that is advantageous for a rotary flow, for example, a circular or elliptical shape. The curved shape of the space inside the well 121a may allow the rotation of the fluid introduced thereinto to continuously occur without a pause and may promote turbulence formation.

A depth of each well 121a may be determined by a thickness of the spacer 121, and the depth may be set to provide an optimal space in which mixing of a reagent and a specimen can be performed effectively.

As illustrated in FIGS. 1 and 2, the diagnostic cartridge 100 includes a first housing 110, a second housing 120, and the filter layer 130.

The sample inlet 111 is formed at one side of the first housing 110. According to one embodiment of the diagnostic cartridge 100, a user may inject a specimen through the sample inlet 111 located at an upper portion of the first housing 110.

The first housing 110 according to one embodiment may be formed of a material that is easy to mold and is chemically and biologically inert. For example, the first housing 110 may be made of various materials including acrylic such as transparent polycarbonate (PC) or polymethyl methacrylate (PMMA), polysiloxane such as polydimethylsiloxane (PDMS), polyethylene such as linear low-density polyethylene (LLDPE), low-density/middle-density/high-density polyethylene (LDPE/MDPE/HDPE), and very-low-density polyethylene (VLDPE), a plastic material such as polyvinyl alcohol, polypropylene (PP), acrylonitrile butadiene styrene (ABS), and cyclic olefin copolymer (COC), glass, mica, silica, and a semiconductor wafer. However, one embodiment is not limited thereto, and the above-listed materials are only examples of materials that may be used as a material of the first housing 110. In other words, any material may be applied as long as the material has chemical and biological stability in addition to machinability.

In one embodiment of the diagnostic cartridge 100, an injection molding technique may be applied to fabrication of the first housing 110.

The second housing 120 is fixed to the other side of the first housing 110 and has the plurality of wells 121a formed thereon.

The first housing 110 and the second housing 120 may be separately fabricated and then coupled through an adhesive or ultrasonic welding in a final assembly process. Such a modular structure not only is a structure that reflects a characteristic in that material costs of subsidiary materials constituting the spacer 121 are high, but also is able to provide flexibility in a manufacturing process and allow each part to be optimized independently.

FIG. 3 illustrates a cross-sectional view along line A-A′ of the diagnostic cartridge according to one embodiment illustrated in FIG. 1.

As illustrated in FIGS. 2 and 3, the filter layer 130 includes a first filter 131 and a second filter 132 and is fixed between the first housing 110 and the second housing 120.

The filter layer 130 according to one embodiment may include a double-layer polymer membrane that serves to filter the fluid sample. When the polymer membrane is provided as double-layer, the fluid sample that has passed through the first polymer membrane of the first filter 131 may be filtered one more time through the second polymer membrane of the second filter 132. In addition, when a large number of particles with a size larger than the size of the pores of the polymer membrane are introduced at one time, tearing of or damage to the polymer membrane can be prevented.

In addition, the filter layer 130 in which a functional material having a specific 10) function is coated on surfaces of the porous membranes removes impurities from inside a specimen and helps only materials of certain particle sizes to move through the microchannel 121b. Through such a filtering system, the possibility of contamination can be reduced, and a highly reliable diagnostic result can be obtained.

As illustrated in FIG. 2, the second housing 120 is separately formed from the 1.5 first housing 110 and includes the cover 122, the spacer 121 adhered to a lower surface of the cover 122 and having the plurality of wells 121a and the microchannel 121b patterned therein, and the base 123 adhered to a lower surface of the spacer 121.

The cover 122, the base 123, and the spacer 121 may each have a thickness of 10 μm to 300 μm. However, the thickness of the cover 122, the base 123, and the spacer 121 is only an example, and a thickness of each layer is not limited in one embodiment.

According to one embodiment of the diagnostic cartridge 100, the cover 122 and the base 123 may be formed in the form of a film and may include a black mask (BM) for absorbing light to block a specific area from being exposed to light. In one embodiment, the black mask may have a shape that surrounds an individual well 121a to block light of one well 121a from permeating into another adjacent well 121a. In still another embodiment, a light shielding ink may be printed to protect the fluid sample moving to the well 121a from external light or prevent an error when measuring optical characteristics in a testing chamber.

The cover 122 and the base 123 according to one embodiment may be fabricated using a transparent polycarbonate (PC) or polymethyl methacrylate (PMMA) material. Further, cover 122 and the base 123 according to one embodiment may be formed of at least one film selected from a polyethylene film such as very-low-density polyethylene (VLDPE), linear low-density polyethylene (LLDPE), low-density polyethylene (LDPE), middle-density polyethylene (MDPE), and high-density polyethylene (HDPE), a polypropylene (PP) film, a polyvinyl chloride (PVC) film, a polyvinyl alcohol (PVA) film, a polystyrene (PS) film, and a polyethylene terephthalate (PET) film.

Unlike the cover 122 and the base 123, the spacer 121 may be fabricated using a porous sheet made of cellulose or the like. Accordingly, the spacer 121 itself serves as a vent and allows the fluid sample to move without a separate driving source. Here, the plurality of wells 121a and the microchannel 121b are formed. The cover 122, the base 123, and the spacer 121 of the second housing may each be fabricated in the form of a sheet and may be laminated to each other and then cut in order to be processed into a part for an individual sensor.

The filter layer 130 may be located between the first housing 110 and the second housing 120 and may be implemented using a porous membrane having a coating layer made of a functional material formed on a surface thereof. The functional material may be a compound including one or more of a functional group containing carbon and hydrogen such as alkane, alkene, alkyne, and arene, a functional group including a halogen atom such as a halogen compound, a functional group including oxygen such as alcohol and ether, a functional group including nitrogen such as amine and nitrile, a functional group including sulfur such as thiol and sulfide, and a functional group including a carbonyl group such as carbonyl, aldehyde, ketone, carboxylic acid, ester, amide, carboxylic acid chloride, and carboxylic acid anhydride.

For example, in a case in which blood is the fluid sample, when blood is introduced through the sample inlet 111 and passes through the filter 130, blood cells may be filtered out, and only plasma or serum may be introduced into the microchannel 121b. A porosity ratio of the polymer membrane may be 1:1 to 1:200, and an average pore diameter may be formed in a range of 0.1 to 10 μm. Here, the porosity ratio is a ratio of sizes of pores formed in the polymer membrane, and more specifically, may indicate a ratio between a size of the smallest pore and a size of the largest pore. A filtering velocity increases with an increase in the porosity ratio.

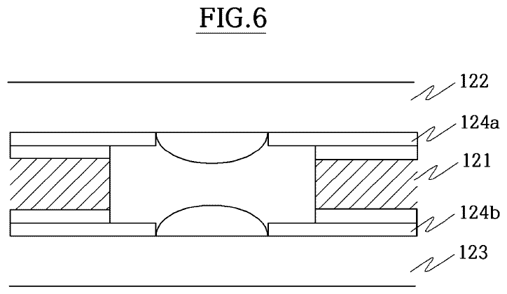

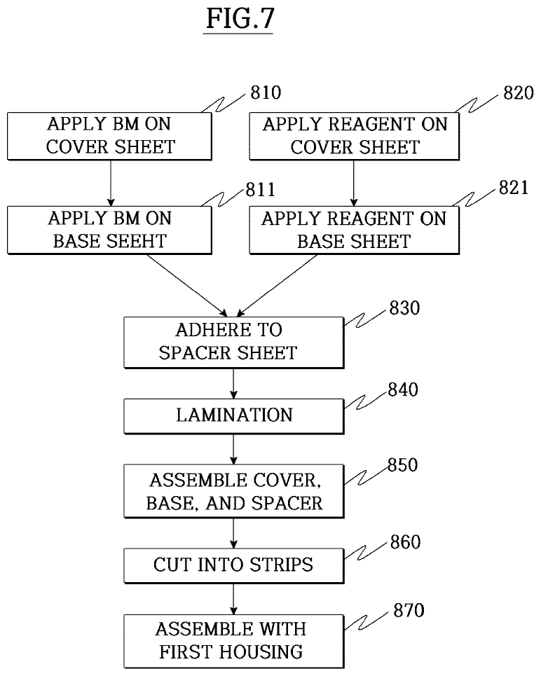

FIG. 6 illustrates a cross-sectional view along line B-B′ of the well 121a that is illustrated in FIG. 5, and FIG. 7 illustrates a flowchart of a process of manufacturing the diagnostic cartridge according to an embodiment.

As illustrated in FIGS. 1, 2, 6, and 7, in the diagnostic cartridge 100 according to one embodiment, a reagent is applied on the cover 122 and each position on the base 123 corresponding to one of the plurality of wells 121a. At this time, a different reagent is applied for each well 121a to enable multiple diagnoses. According to an embodiment, the manufacturing process begins with the steps of applying BM to the cover sheet 810 and applying BM to the base sheet 820, respectively. After BM is applied to each sheet, the steps of applying reagent to the cover sheet 811 and applying reagent to the base sheet 821 are sequentially performed. These two sheets, having undergone the preparatory processes, are then adhered to a spacer sheet in the next step 830. After adhesion to the spacer sheet, a lamination process 840 is performed, which leads to the assembly of the cover, base, and spacer components 850. The assembled structure undergoes cutting into strip units 860, and is finally completed by assembly with the first housing 870. This process enables the formation of a robust composite structure while optimizing the characteristics of each layer.

A reagent application process of the diagnostic cartridge 100 according to one embodiment may be performed by, before the cover 122 and the base 123 are coupled to the spacer 121, using automated dispensing equipment to precisely apply a specific reagent on a position of each well 121a. As an application method, screen printing, pin spotting, micropipetting, inkjet printing, or the like may be used. The applied reagent may undergo a drying process for the reagent to be stabilized in the well 121a.

A different reagent may be applied on each of the plurality of wells 121a of the diagnostic cartridge 100 according to a testing item. A reagent for checking the presence/absence of a liver disease, a kidney disease, or a lipid metabolism abnormality may be held in each well 121a.

For example, an enzyme for detecting creatinine which is a major biomarker that indicates the possibility of renal failure, uremia, heart failure, or the like may be applied on the first well 121a, an enzyme for detecting albumin which can evaluate liver damage or a protein metabolism abnormality may be applied on the second well 121a, and an enzyme for detecting total cholesterol which is useful for determining a lipid metabolism abnormality and a risk of arteriosclerosis may be applied on the third well 121a.

In each well 121a, a color developer, a buffer solution, a catalytic agent, an enzyme activator, and the like may be included together with the enzyme that can detect the corresponding marker. The corresponding marker that is present in blood may react with a detecting enzyme present in the well 121a and generate a reaction product, and the reaction product may react with a color developer and induce a color change. A degree of the color change is measured at a specific wavelength and converted into a detectable signal, and in this way, a numerical value is calculated. Alternatively, the marker itself may directly react with a color developer and form a complex, and a concentration of the complex may be measured at a specific wavelength and analyzed using a detection signal to calculate a final numerical value. Different types of reagents may be applied on the cover 122 and the base 123, and the reagents may have different functions when reacting with a specimen.

As illustrated in FIGS. 1 and 2, the filter layer 130 of the diagnostic cartridge 100 is located between the first housing 110 and the second housing 120 and consists of the first filter 131 and the second filter 132 that are different types of filters.

The filter layer 130 according to one embodiment may be implemented to have a structure in which a functional material is filled between double layers of porous membranes. For example, when boronic acid or concanavalin A (ConA) is filled between the double layers of porous membranes, glycated hemoglobin of a patient can 20) be efficiently measured.

A filter upper adhesive layer 133a and a filter lower adhesive layer 133b may be fabricated using a medical acrylic-based double-sided tape according to one embodiment and may have a thickness of about 80 to 120 μm. A sufficient bonding force may be provided to prevent the filter from being detached during use of the cartridge due to an adhesive strength. The filter upper adhesive layer 133a and the filter lower adhesive layer 133b may be laser cut corresponding to a diameter of the filter to fix the filter at an accurate position.

The first filter 131 according to one embodiment is a glass fiber filter having a matrix structure of randomly arranged glass fibers (GFs) and may have an air gap size of about 2 to 5 μm and a thickness of about 200 to 400 μm. The filter may mostly operate using a depth filtration method and may effectively separate blood cells.

The second filter 132 according to one embodiment may be configured as a PC membrane filter that performs surface filtration through a precise cylindrical air gap generated by a laser. The filter may serve to remove fine particles and specific materials from inside serum.

For instance, the filter layer 130 may allow highly pure serum to be obtained by removing large particles such as blood cells by the first filer 131 and then filtering smaller particles and specific materials by the second filter 132 from a fluid sample sequentially passing through the first filter 131 and the second filter 132 that are different types of filters. Through such a double-filter structure, impurities can be thoroughly removed in stages from a blood sample, and only a necessary component can be extracted.

As illustrated in FIGS. 2 and 6, the diagnostic cartridge 100 has a structure in which the spacer 121 and the base 123 belong to the second housing 120, and an upper adhesive layer 124a and a lower adhesive layer 124b are interposed between the spacer 121 and the cover 122.

The upper adhesive layer 124a and the lower adhesive layer 124b may be fabricated using a double-sided tape and may be laser cut to exactly correspond to a pattern of the wells 121a and the microchannel 121b. The upper adhesive layer 124a and the lower adhesive layer 124b according to one embodiment of the diagnostic cartridge 100 may be made of a biocompatible material and may have a low auto-fluorescence characteristic of not affecting chemical properties of a specimen sample and not causing interference with fluorescence measurement.

The upper adhesive layer 124a may seal lower sides of the microchannel 121b and the plurality of wells 121a between the spacer 121 and the cover 122 to prevent leakage of a fluid. Likewise, the lower adhesive layer 124b may seal upper sides of the microchannel 121b and the plurality of wells 121a between the spacer 121 and the base 10) 123 to prevent leakage of a fluid.

Such a multi-layer adhesive structure can increase the structural stability of the diagnostic cartridge 100, maintain precise alignment between internal components, and provide convenience of assembly in a manufacturing process. In particular, airtight sealing through the adhesive layers may allow a fluid flow in the microchannel 121b to be accurately controlled and may improve reproducibility and reliability of a diagnostic result.

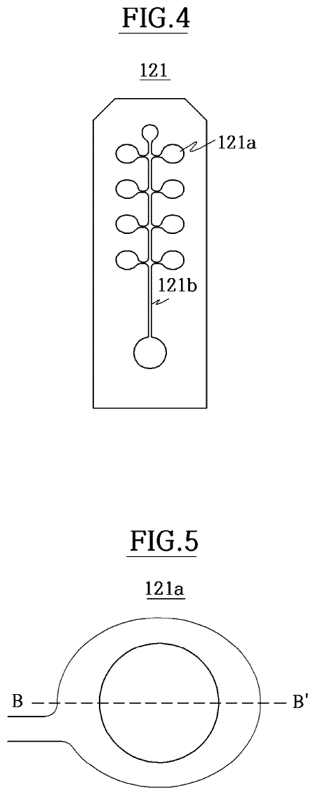

FIG. 4 illustrates a plan view of the spacer 121 showing a pattern of the microchannel 121b according to an embodiment, and FIG. 5 illustrates an enlarged plan view of the well 121a that belongs to the pattern of the microchannel 121b according to an embodiment.

As illustrated in FIGS. 4 and 5, the diagnostic cartridge 100 has a structure in which a turbulence is generated inside each well 121a and a reagent is evenly mixed with a specimen sample. The turbulence generation is effectively performed mostly by the microchannel 121b being eccentrically interfaced with the well 121a.

As can be seen in FIG. 5, the microchannel 121b is connected to a boundary of the well 121a, but a point where the microchannel meets the well 121a is eccentric from a center line of the well 121a that is indicated by a dotted line. In such a structure, when a specimen is introduced into the well 121a through the microchannel 121b, the specimen rotates along a curved boundary of the well 121a.

According to fluid dynamics, a centrifugal force is generated when a fluid moves along a curved path, and the centrifugal force causes a turbulence to be generated clockwise or counterclockwise inside the well 121a. In the present embodiment, generation of a turbulence in one direction due to such an eccentric structure has shown to shorten a reagent-specimen mixing time and improve mixing uniformity compared to the conventional central connection method.

According to the present disclosure, a diagnostic cartridge has a new structure that facilitates manufacture and assembly. Since effective mixing in a reaction area is possible, and fluid dynamics principles are utilized without the aid of an external device, a washout phenomenon in which a reagent pre-applied inside a well is washed out can be minimized. In this way, since a natural turbulence is generated in the reaction area, the mixing efficiency of reagents and specimens can be improved.

Specifically, since a reagent and a specimen are uniformly mixed by a turbulence generated inside a well without an external stirring device, the reaction efficiency can be increased, and detection sensitivity and accuracy can be improved. These may contribute to the size reduction and cost reduction of a device. Further, a specimen may be evenly dispersed by minimizing a section in which the specimen stagnates when a fluid introduced into a well having a structure in which a corner and a blind spot are not present to be optimized for turbulence formation rotates.

In addition, a method in which a different reagent is applied for each well provides a multiple testing function that allows multiple items to be simultaneously tested using a single specimen, thereby improving the testing efficiency.

In addition, since the reaction efficiency increases due to the turbulence, a detection time can be shortened.

In addition, flexibility can be improved in a process of manufacturing a modular housing structure.

Further, a structure in which a plurality of filters are mounted provides multi-stage filtering, thereby enabling precise preprocessing, stably fixing the filters to prevent leakage of a specimen, and ensuring an efficient serum separation function.

Further, since firm coupling between key components in the cartridge is provided, the structural stability of the cartridge can be increased, and accuracy of alignment between the internal components can be maintained.

To sum up the effects, the diagnostic cartridge according to the present disclosure is an innovative medical diagnostic tool that combines ease of use, analytical efficiency, ease of manufacture, and a multiple analysis function and is expected to be widely utilized in the point-of-care testing (POCT) field.

Various embodiments disclosed in this specification and drawings only present specific examples to help understanding, and it is not intended to limit the scope of various embodiments of the present disclosure.

Therefore, in addition to the embodiments described herein, all changes or modifications derived based on the technical spirit of various embodiments of the present disclosure should be construed as being included in the scope of various embodiments of the present disclosure.

What is claimed is:

1. A diagnostic cartridge comprising:
a sample inlet;
a filter layer located at a downstream portion of the sample inlet and separating serum from an injected sample;
a plurality of wells located at a downstream portion of the filter layer; and
a microchannel branched from the sample inlet to each of the plurality of wells, interfacing eccentrically from a center line of each well.

2. The diagnostic cartridge of claim 1, wherein the plurality of wells each have a substantially circular or elliptical shape.

3. The diagnostic cartridge of claim 1, further comprising:
a first housing having the sample inlet formed at one side; and
a second housing fixed to the other side of the first housing and having the plurality of wells formed thereon,
wherein the filter layer includes a first filter and a second filter and is fixed between the first housing and the second housing.

4. The diagnostic cartridge of claim 3, wherein the second housing includes:
a cover;
a spacer adhered to a lower surface of the cover and having the plurality of wells and the microchannel patterned therein; and
a base adhered to a lower surface of the spacer.

5. The diagnostic cartridge of claim 4, further comprising:
areas corresponding to the plurality of wells of the spacer on the lower surface of the cover; and
different reagents applied on a plurality of sites that are at least some portions of the areas corresponding to the plurality of wells of the spacer on an upper surface of the base.

6. The diagnostic cartridge of claim 3, further comprising:
a filter upper adhesive layer interposed between the first filter and the second filter; and
a filter lower adhesive layer interposed at a lower surface of the second filter located at a lower portion of the filter upper adhesive layer.

7. The diagnostic cartridge of claim 4, further comprising:
an upper adhesive layer interposed between the spacer and the cover; and
a lower adhesive layer interposed between the spacer and the base.

8. The diagnostic cartridge of claim 1, wherein a turbulence is generated in which a specimen sample injected along the microchannel rotates in one direction inside each well.
